(19) United States
(12) Patent Application Publication
(10) Pub. No.: US 2014/0193140 A1
(43) Pub. Date: Jul. 10, 2014

(54) SYSTEM AND METHOD FOR SLOW MOTION DISPLAY, ANALYSIS AND/OR EDITING OF AUDIOVISUAL CONTENT ON A MOBILE DEVICE

(71) Applicant: ICONIC SPORTS TECHNOLOGY, INC., Daingerfield, TX (US)

(72) Inventors: SANDY FLIDERMAN, ALBERTSON, NY (US); KAPIL DHAWAN, NORTH BABYLON, NY (US)

(21) Appl. No.: 13/965,004

(22) Filed: Aug. 12, 2013

Related U.S. Application Data
(60) Provisional application No. 61/682,504, filed on Aug. 13, 2012.

(51) Int. Cl. G11B 27/00; H04N 9/87

(52) U.S. Cl. CPC G11B 27/005; H04N 9/87
USPC 386/343

(57) ABSTRACT

A method for slow motion display of audiovisual content on a mobile device comprises storing a plurality of videos in a memory; providing a first video window configured to include a start/pause control, frame control and video display area for display of a first video; and determining, by a display orientation sensor, whether the touchscreen is in portrait or landscape orientation. If in portrait orientation, the first video window occupies substantially the entire viewing area. If in landscape orientation, the first video window occupies a first portion of the viewing area and an analysis window occupies a second portion of the viewing area. The analysis window includes either a menu displaying a list of videos for selection as a second video, or if a second video has been selected, a second video window including independent start/pause control, frame control, and video display area for independent display of the second video.

### CROSS-REFERENCE TO RELATED APPLICATIONS

This application claims benefit of U.S. Provisional Application No. 61/682,504, filed Aug. 13, 2012, entitled SYSTEM AND METHOD FOR SLOW MOTION DISPLAY, ANALYSIS AND/OR EDITING OF AUDIOVISUAL CONTENT ON A MOBILE DEVICE (Atty. Dkt. No. VMIS-31188), the specification of which is incorporated herein in its entirety.

### TECHNICAL FIELD

The invention relates to a system and method for slow motion display, analysis or editing of audiovisual content on a mobile device. In particular, the invention relates to a system and method for simultaneously displaying two videos on a single display screen and providing independent playback controls for each video.

### BACKGROUND

It is known to play audiovisual content, commonly known as videos, on mobile devices such as smart phones, tablet computers and the like. A need exists, for systems and methods to facilitate analysis of videos by allowing a user to play multiple videos on one mobile device with independent controls for each video. A need further exists, for systems and methods for the creation of an analysis session image comprising content from a source video along with user-added analysis content.

### SUMMARY

In a first aspect of the invention, a method for execution on a mobile device for slow motion display of audiovisual content on the mobile device is provided, the mobile device having a processor, a touchscreen display operatively coupled to the processor and having a rectangular screen viewable in either a portrait orientation or a landscape orientation, a memory operatively coupled to the processor, a communication device operatively coupled to the processor, and a display orientation sensor operatively coupled to the processor. The method comprises the following steps: storing a plurality of videos comprising audiovisual content in a memory of a mobile device; providing a first video window on a touchscreen display of the mobile device, the first video window being configured by a processor of the mobile device to include a first playback start/pause control operatively coupled to the processor for receiving first playback start/pause inputs from the touchscreen display and providing signals indicative of the first playback start/pause inputs to the processor, a first frame control operatively coupled to the processor for receiving first frame control inputs from the touchscreen display and providing signals indicative of the first frame control inputs to the processor, and a first video display area within which a first video of the plurality of videos is displayed from the memory by the processor in response to the signals indicative of the first playback start/pause inputs and the first frame control inputs; determining, by a display orientation sensor of the mobile device, whether the touchscreen display is in a portrait orientation, wherein the height of the screen is greater than the width of the screen, or a landscape orientation, wherein the width of the screen is greater than the height of the screen, and providing an orientation signal to the processor indicative of the determined orientation of the touchscreen display; configuring the touchscreen display, if the orientation signal received by the processor is indicative that the touchscreen display is in a portrait orientation, such that the first video window occupies substantially the entire viewing area of the touchscreen display; and configuring the touchscreen display, if the orientation signal received by the processor is indicative that the touchscreen display is in a landscape orientation, such that the first video window occupies a first portion of the viewing area of the touchscreen display and an analysis window occupies a second portion of the viewing area of the touchscreen display adjacent to the first portion, wherein the analysis window includes either if a second video has not been selected from the plurality of videos, a menu window displaying a list of videos stored in the memory and allowing selection of one of the plurality of videos as the second video, or if a second video has been selected from the plurality of videos, a second video window, the second video window being configured by the processor to include a second playback start/pause control operatively coupled to the processor for receiving second playback start/pause inputs from the touchscreen display and providing the second start/pause inputs to the processor, a second frame control operatively coupled to the processor for receiving second frame control inputs from the touchscreen display and providing the second frame control inputs to the processor, and a second video display area within which the second video is displayed from the memory by the processor in response to the second playback start/pause inputs and the second frame control inputs.

In another embodiment, if the orientation signal received by the processor is indicative that the touchscreen display is in a landscape orientation and a second video has been selected, then the touchscreen is configured such that the dimensions of the first portion containing the first video window are substantially the same as the dimensions of the second portion containing the second video window.

In still another embodiment, the first portion containing the first video window occupies about 50% of the viewing area of the touchscreen and the second portion containing the second video window occupies about 50% of the viewing area of the touchscreen.

In a yet another embodiment, each of the first frame control and the second frame control are configurable in at least two different configurations for controlling the playback direction and speed of the respective video.

In a further embodiment, each of the first frame control and the second frame control are configurable as a touchscreen wheel that causes the respective video to play frame by frame forward as the wheel is turned in a first direction and to play frame by frame in reverse as the wheel is turned in the opposite direction.

In another embodiment, each of the first frame control and the second frame control are configurable as a touchscreen slider that causes the respective video to play forward at a rate proportional to a distance of the slider from a center in a first direction and to play in reverse at a rate proportional to the distance of the slider from the center in the opposite direction.

In another embodiment, the method further comprises the following steps: selecting a source video from the plurality of videos; creating a video layer in the memory including audio and video content from the source video modified in accordance with the signals indicative of the first playback start/pause control inputs and the first frame control inputs received by the processor during an analysis session, creating a drawing layer in the memory including signals indicative of a graphical input and a graphical content input from the user and received by the processor during the analysis session; creating a voice over layer in the memory including audio content recorded by the user and received by the processor during the analysis session; and rendering, after the analysis session, the video layer, drawing layer and the voice over layer together with the processor to create an audiovisual session image in the memory.

In still another embodiment, the graphical input and graphical content comprises one or more of the following: inputs indicative of the user selecting, by means of the touchscreen display, a predefined shape from a plurality of predefined shapes; inputs indicative of the user positioning, by means of the touchscreen display, a predefined shape on an active viewing area of the touchscreen display; inputs indicative of the user resizing, by means of the touchscreen display, a predefined shape; inputs indicative of the user drawing freehand on the active viewing area, by means of the touchscreen display; or inputs indicative of the user erasing the active viewing area, by means of the touchscreen display, to remove any then current graphical input and graphical content.

In a further embodiment, the method further comprises the following steps: transmitting a session image from the memory using the communication device to a remote device; and activating a push notification to appear on a display of the remote device indicative that the session image has been sent.

In another embodiment, the method further comprises the following steps: receiving a modified session image from a remote device with the communication device and storing the modified session image in the memory; and activating a push notification to appear on the touchscreen display using the processor indicative that the modified session image has been received from the remote device.

In another embodiment, the method further comprises displaying the modified session image from the memory to either the first video display area or the second video display area using the processor in response to the respective first or second playback start/pause inputs and the respective first or second frame control inputs.

In another aspect of the invention, a system for slow motion display of audiovisual content is provided, comprising a mobile device having a processor, a touchscreen display operatively coupled to the processor and having a rectangular screen viewable in either a portrait orientation or a landscape orientation, a memory operatively coupled to the processor, a communication device operatively coupled to the processor, and a display orientation sensor operatively coupled to the processor. Executable code is stored in the memory of the mobile device for storing a plurality of videos comprising audiovisual content in a memory of a mobile device. Executable code is also stored in the memory of the mobile device for providing a first video window on a touchscreen display of the mobile device, the first video window being configured by a processor of the mobile device to include a first playback start/pause control operatively coupled to the processor for receiving first playback start/pause inputs from the touchscreen display and providing signals indicative of the first playback start/pause inputs to the processor, a first frame control operatively coupled to the processor for receiving first frame control inputs from the touchscreen display and providing signals indicative of the first frame control inputs to the processor, and a first video display area within which a first video of the plurality of videos is displayed from the memory by the processor in response to the signals indicative of the first playback start/pause inputs and the first frame control inputs. Executable code is also stored in the memory of the mobile device for determining, by a display orientation sensor of the mobile device, whether the touchscreen display is in a portrait orientation, wherein the height of the screen is greater than the width of the screen, or a landscape orientation, wherein the width of the screen is greater than the height of the screen, and providing an orientation signal to the processor indicative of the determined orientation of the touchscreen display. Executable code is also stored in the memory of the mobile device for configuring the touchscreen display, if the orientation signal received by the processor is indicative that the touchscreen display is in a portrait orientation, such that the first video window occupies substantially the entire viewing area of the touchscreen display. Executable code is further stored in the memory of the mobile device for configuring the touchscreen display, if the orientation signal received by the processor is indicative that the touchscreen display is in a landscape orientation, such that the first video window occupies a first portion of the viewing area of the touchscreen display and an analysis window occupies a second portion of the viewing area of the touchscreen display adjacent to the first portion. The analysis window includes either: if a second video has not been selected from the plurality of videos, a menu window displaying a list of videos stored in the memory and allowing selection of one of the plurality of videos as the second video; or if a second video has been selected from the plurality of videos, a second video window, the second video window being configured by the processor to include a second playback start/pause control operatively coupled to the processor for receiving second playback start/pause inputs from the touchscreen display and providing the second start/pause inputs to the processor, a second frame control operatively coupled to the processor for receiving second frame control inputs from the touchscreen display and providing the second frame control inputs to the processor, and a second video display area within which the second video is displayed from the memory by the processor in response to the second playback start/pause inputs and the second frame control inputs.

### BRIEF DESCRIPTION OF THE DRAWINGS

For a more complete understanding, reference is now made to the following description taken in conjunction with the accompanying Drawings in which:

FIG. 1 is a schematic drawing of a system for executing a method for displaying slow motion video on a mobile device in accordance with one embodiment;

FIG. 2 illustrates the mobile device of FIG. 1 in portrait mode;

FIG. 3 illustrates the mobile device of FIG. 1 in landscape mode; and

FIG. 4 illustrates a system for executing a method for recording a session image on a mobile device in accordance with another embodiment.

### DETAILED DESCRIPTION

Referring now to the drawings, wherein like reference numbers are used herein to designate like elements throughout, the various views and embodiments of a system and method for slow motion display, analysis and/or editing of audiovisual content on a mobile device are illustrated and described, and other possible embodiments are described. The figures are not necessarily drawn to scale, and in some instances the drawings have been exaggerated and/or simplified in places for illustrative purposes only. One of ordinary skill in the art will appreciate the many possible applications and variations based on the following examples of possible embodiments.

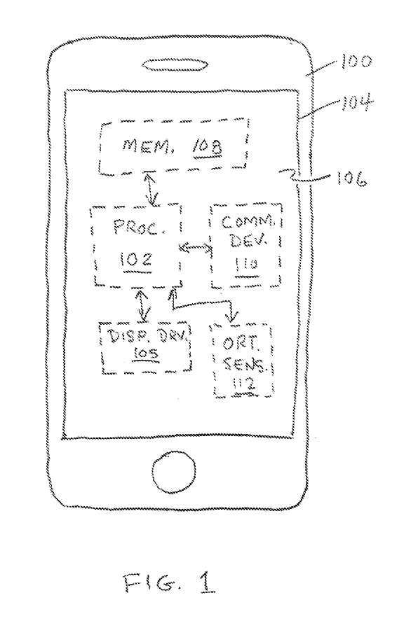

Referring now to FIG. 1, there is illustrated a system for slow motion display of audiovisual content on a mobile device in accordance with one aspect of the invention. The mobile device 100 includes a processor 102, a touchscreen display 104 operatively coupled to the processor (e.g., via display driver 105) and having a rectangular screen 106 viewable in either a portrait orientation or a landscape orientation, a memory 108 operatively coupled to the processor, a communication device 110 operatively coupled to the processor, and a display orientation sensor 112 operatively coupled to the processor. A plurality of videos comprising audiovisual content may be stored in the memory 108 of the mobile device 100.

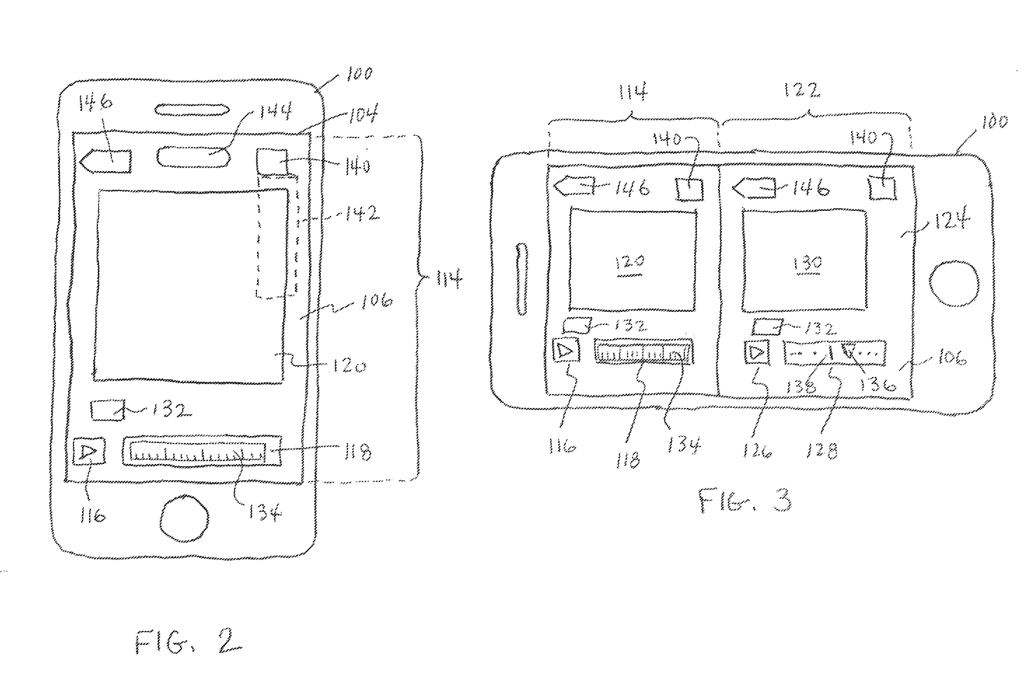

Referring now also to FIG. 2, a first video window 114 is provided on the touchscreen display 104 of the mobile device 100. The first video window 114 may be configured by the processor 102 of the mobile device 100 to include a first playback start/pause control 116 operatively coupled to the processor for receiving first playback start/pause inputs from the touchscreen display 104 and providing signals indicative of the first playback start/pause inputs to the processor.

The first video window 114 may be further configured by the processor 102 of the mobile device 100 to include a first frame control 118 operatively coupled to the processor for receiving first frame control inputs from the touchscreen display 104 and providing signals indicative of the first frame control inputs to the processor.

The first video window 114 may be still further configured by the processor 102 of the mobile device 100 to include a first video display area 120 within which a first video of the plurality of videos is displayed from the memory 108 by the processor in response to the signals indicative of the first playback start/pause inputs and the first frame control inputs. Videos may be selected from the plurality of videos stored in the memory 108 by using a library icon 146 to call a selection menu for the respective video window.

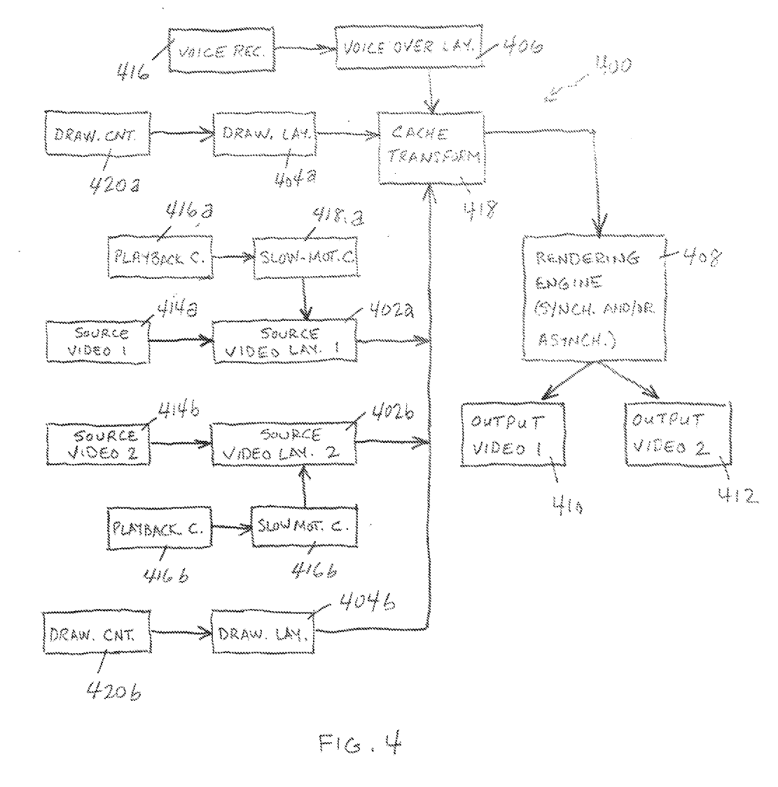

Referring now also to FIG. 3, the display orientation sensor 112 may be used to determine whether the touchscreen display 104 is in a portrait orientation, wherein the height of the screen 106 is greater than the width of the screen (see FIG. 2), or a landscape orientation, wherein the width of the screen is greater than the height of the screen (see FIG. 3), and providing an orientation signal to the processor 102 indicative of the determined orientation of the touchscreen display. If the orientation signal received by the processor 102 is indicative that the touchscreen display 104 is in a portrait orientation, then the processor may configure the touchscreen display such that the first video window 114 occupies substantially the entire viewing area 106 of the touchscreen display (see FIG. 2). Alternatively, if the orientation signal received by the processor 102 from the orientation sensor 112 is indicative that the touchscreen display 104 is in a landscape orientation, then the processor 102 may configure the touchscreen display such that the first video window 114 occupies a first portion of the viewing area 106 of the touchscreen display and an analysis window 122 occupies a second portion of the viewing area of the touchscreen display adjacent to the first portion (see FIG. 3). In preferred embodiments, the first portion is substantially the same size as the second portion. In more preferred embodiment, the first video window 114 occupies about 50% of the viewing area of the screen 106 and the second video window 124 occupies about 50% of the viewing area.

The analysis window 122 may be configured in at least two different ways. If a second video has not been selected from the plurality of videos, then the analysis window 122 may be configured by the processor 102 as a menu window (not shown) displaying a list of videos stored in the memory 108 and allowing selection of one of the plurality of videos as the second video. Alternatively, if a second video has been selected from the plurality of videos, then the analysis window 122 may be configured by the processor 102 as a second video window 124 (as shown in FIG. 3).

The second video window 124 may be configured by the processor 102 of the mobile device 100 to include a second playback start/pause control 126 operatively coupled to the processor for receiving second playback start/pause inputs from the touchscreen display 104 and providing signals indicative of the second playback start/pause inputs to the processor.

The second video window 124 may be further configured by the processor 102 of the mobile device 100 to include a second frame control 128 operatively coupled to the processor for receiving second frame control inputs from the touchscreen display 104 and providing signals indicative of the second frame control inputs to the processor.

The second video window 124 may be still further configured by the processor 102 of the mobile device 100 to include a second video display area 130 within which a second video of the plurality of videos is displayed from the memory 108 by the processor in response to the signals indicative of the second playback start/pause inputs and the second frame control inputs.

There are several tools to analyze the video in each video window 114, 124. At the bottom, the user can play the selected video at regular speed using the respective playback start/pause 116, 126 or focus in on a precise movement by manually controlling the speed using the respective frame control 118, 128. A toggle 132 above each respective play button 116, 126 allows the user to switch the frame control 118, 128 between dial mode and gauge mode. Screen drawing tools are also provided.

With the frame control in dial mode (also known as wheel mode), the first frame control 118 and/or the second frame control 128 are configured as a touchscreen wheel 134 (FIG. 3) that causes the respective video to play frame by frame forward as the wheel is turned in a first direction and to play frame by frame in reverse as the wheel is turned in the opposite direction. With the frame control in gauge mode, the first frame control 118 and/or the second frame control 128 are configured as a touchscreen slider 136 (FIG. 3) that causes the respective video to play forward at a rate proportional to a distance of the slider from a center 138 in a first direction and to play in reverse at a rate proportional to the distance of the slider from the center in the opposite direction.

Screen drawing tools may be activated, e.g., by tapping a drawing tool icon 140 on the respective video window 114, 124. Tapping the icon 140 activates a drop-down window 142 with preselected graphic shapes that may be selected by the user, positioned on the respective video display area 120, 130 by the user and/or resized by the user. The user may also add graphic content as a freehand drawing via the touchscreen 104. The user may also erase the graphic content on the respective video display area (independent of the content on the adjacent video display area). Graphic content added via the drawing tools during an analysis recording and the earlier drawings will be preserved where you placed them. This allows the user to add, modify and/or delete graphic content in real time and to be saved in a session recording.

Referring now to FIG. 4, there is shown a system and method 400 for creating a session image of a video that incorporates original video content with user-added graphic content and/or voice over (audio) content. After recording an analysis session, a new video 401 called a “session image” is produced by combining a video layer 402, a drawing layer 404 and a voice over layer 406 using a rendering engine 408 to produce a single integrated video, e.g., first output video 410 or second output video 412. The respective session image 410, 412 is a recording of the real time appearance of the respective video display window 120, 130 as it appeared during the analysis session (including any playback control or additional graphical content as it was displayed on screen), and of the real time audio recorded during the analysis session (mixed with the original audio, if present).

The video layer 402a, 402b (in the example of FIG. 4, two independent video streams are shown, denoted “a” and “b”) comprises audio and video content from the original source video 414a, 414b which is modified in accordance with real time playback and slow motion control inputs 416a, 416b and 418a, 418b made by the user via the playback controls 116, 126 and slow motion controls 118, 128 during the recording of the analysis session. The video layer 402a, 402b thus compiles a record of the real time appearance of the respective video as seen in the display window 114, 124 during the recording of the analysis session, including all playback pauses, forward playback, reverse playback, slow-motion playback and/or frame-by-frame playback of the video content.

The drawing layer 404a, 404b comprises one or more graphical inputs or graphical content 420a, 420b received from the user during the respective analysis session. The graphical inputs and content 420a, 420b may correspond to the user selecting, e.g., by means of a touchscreen window 142, a predefined shape from a plurality of predefined shapes, to the user positioning a predefined shape on the screen, or to the user resizing a predefined shape. The graphical inputs and content 420a, 420b may further correspond to the user drawing freehand lines on the screen, e.g., by means of a touchscreen. The graphical inputs and content 420a, 420b may still further correspond to the user erasing the screen to remove any then current graphical content. The drawing layer 404a, 404b further comprises synchronization information identifying at what point of the recording of the respective analysis session each graphical input or content was received. The synchronization information for each graphical input may be in the form of a real time session timestamp, video frame timestamp or other type of synchronizing data. The drawing layer 404a, 404b thus creates a record of the real time appearance of the added graphical content (i.e., other than the original video content) seen in the respective display window 120, 130 during the recording of the analysis session.

The voice over layer 406 comprises audio content 416 recorded during the analysis session. The voice over layer 406 further comprises synchronization information identifying at what point of the recording of the analysis session the audio content was received. The synchronization information for the audio content may be in the form of a real time session timestamp, video frame timestamp or other type of synchronizing data. The voice over layer 406 thus creates a record of the real time audio environment (i.e., other than the audio content of the original video) as heard during the recording of the analysis session

Before recording an analysis session, a first or second video is selected for analysis using the library icon 146 on the touchscreen 104. The recording of an analysis session may be initiated by pressing the record icon 144 (FIG. 1) on the touchscreen 104. During the analysis session, a record of the real time video content displayed in the video window 120, 130 (including playback, pauses, frame-by-frame movement) is created, along with a record of the real time graphic content and audio recording made at the time the video content is shown. After recording an analysis session, a new video 401 called a “session image” is produced by combining a video layer 402, a drawing layer 404 and a voice over layer 406 using a rendering engine 408 to produce a single integrated video, e.g., first output video 410 or second output video 412. The respective session image 410, 412 is a recording of the real time appearance of the respective video display window 120, 130 as it appeared during the analysis session (including any playback control or additional graphical content as it was displayed on screen), and of the real time audio recorded during the analysis session (mixed with the original audio, if present).

After the video layer 402, drawing layer 404 and voice over layer 406 are created as described above, the layers are routed through a cache transform 418 to the rendering engine 408. Either one feed (i.e., 402, 404 and 408) or two feeds (i.e., 402a, 404a and 406a plus 402b, 404b and 406b) may be sent to the rendering engine 408. The rendering engine combines the respective layers to produce output videos 410, 412, which are the respective session images. If multiple images are being rendered, the rendering by the rendering engine 408 may be synchronous or asynchronous. The session image 410, 412 is stored in the memory 108 of the mobile device 100 for later playback or other use.

After creation of a session image 410, 412, the system and method may cause the processor 102 of the mobile device 100 to transmit the session image from the memory 108 using the communication device 110 to a remote device (not shown). The system and method may further activate a push notification to appear on a display of the remote device indicative that the session image has been sent.

The system and method may further receive a modified session image from a remote device with the communication device 110 and store the modified session image in the memory 108. The system and method may activate a push notification to appear on the touchscreen display 104 using the processor 102 indicative that the modified session image has been received from the remote device. The modified session image may be displayed from the memory 108 to either the first video display area 120 or the second video display area 130 using the processor 102 in response to the respective first or second playback start/pause inputs 116, 126 and the respective first or second frame control inputs 118, 128.

It will be appreciated by those skilled in the art having the benefit of this disclosure that this system and method for slow motion display, analysis and/or editing of audiovisual content on a mobile device provides a unique set of features to users. It should be understood that the drawings and detailed description herein are to be regarded in an illustrative rather than a restrictive manner, and are not intended to be limiting to the particular forms and examples disclosed. On the contrary, included are any further modifications, changes, rearrangements, substitutions, alternatives, design choices, and embodiments apparent to those of ordinary skill in the art, without departing from the spirit and scope hereof, as defined by the following claims. Thus, it is intended that the following claims be interpreted to embrace all such further modifications, changes, rearrangements, substitutions, alternatives, design choices, and embodiments.

What is claimed is:

1. A method for execution on a mobile device for slow motion display of audiovisual content on the mobile device, the mobile device having a processor, a touchscreen display operatively coupled to the processor and having a rectangular screen viewable in either a portrait orientation or a landscape orientation, a memory operatively coupled to the processor, a communication device operatively coupled to the processor, and a display orientation sensor operatively coupled to the processor, the method comprising the following steps:
storing a plurality of videos comprising audiovisual content in a memory of a mobile device;
providing a first video window on a touchscreen display of the mobile device, the first video window being configured by a processor of the mobile device to include
a first playback start/pause control operatively coupled to the processor for receiving first playback start/pause inputs from the touchscreen display and providing signals indicative of the first playback start/pause inputs to the processor,
a first frame control operatively coupled to the processor for receiving first frame control inputs from the touchscreen display and providing signals indicative of the first frame control inputs to the processor, and
a first video display area within which a first video of the plurality of videos is displayed from the memory by the processor in response to the signals indicative of the first playback start/pause inputs and the first frame control inputs;
determining, by a display orientation sensor of the mobile device, whether the touchscreen display is in a portrait orientation, wherein the height of the screen is greater than the width of the screen, or a landscape orientation, wherein the width of the screen is greater than the height of the screen, and providing an orientation signal to the processor indicative of the determined orientation of the touchscreen display;
configuring the touchscreen display, if the orientation signal received by the processor is indicative that the touchscreen display is in a portrait orientation, such that the first video window occupies substantially the entire viewing area of the touchscreen display; and
configuring the touchscreen display, if the orientation signal received by the processor is indicative that the touchscreen display is in a landscape orientation, such that the first video window occupies a first portion of the viewing area of the touchscreen display and an analysis window occupies a second portion of the viewing area of the touchscreen display adjacent to the first portion, wherein the analysis window includes either
if a second video has not been selected from the plurality of videos, a menu window displaying a list of videos stored in the memory and allowing selection of one of the plurality of videos as the second video, or
if a second video has been selected from the plurality of videos, a second video window, the second video window being configured by the processor to include
a second playback start/pause control operatively coupled to the processor for receiving second playback start/pause inputs from the touchscreen display and providing the second start/pause inputs to the processor,
a second frame control operatively coupled to the processor for receiving second frame control inputs from the touchscreen display and providing the second frame control inputs to the processor, and
a second video display area within which the second video is displayed from the memory by the processor in response to the second playback start/pause inputs and the second frame control inputs.

2. A method in accordance with claim 1, wherein if the orientation signal received by the processor is indicative that the touchscreen display is in a landscape orientation and a second video has been selected, then the touchscreen is configured such that the dimensions of the first portion containing the first video window are substantially the same as the dimensions of the second portion containing the second video window.

3. A method in accordance with claim 2, wherein the first portion containing the first video window occupies about 50% of the viewing area of the touchscreen and the second portion containing the second video window occupies about 50% of the viewing area of the touchscreen.

4. A method in accordance with claim 1, wherein each of the first frame control and the second frame control are configurable in at least two different configurations for controlling the playback direction and speed of the respective video.

5. A method in accordance with claim 4, wherein each of the first frame control and the second frame control are configurable as a touchscreen wheel that causes the respective video to play frame by frame forward as the wheel is turned in a first direction and to play frame by frame in reverse as the wheel is turned in the opposite direction.

6. A method in accordance with claim 4, wherein each of the first frame control and the second frame control are configurable as a touchscreen slider that causes the respective video to play forward at a rate proportional to a distance of the slider from a center in a first direction and to play in reverse at a rate proportional to the distance of the slider from the center in the opposite direction.

7. A method in accordance with claim 1, further comprising the following steps:
selecting a source video from the plurality of videos;
creating a video layer in the memory including audio and video content from the source video modified in accordance with the signals indicative of the first playback start/pause control inputs and the first frame control inputs received by the processor during an analysis session,
creating a drawing layer in the memory including signals indicative of a graphical input and a graphical content input from the user and received by the processor during the analysis session;
creating a voice over layer in the memory including audio content recorded by the user and received by the processor during the analysis session; and
rendering, after the analysis session, the video layer, drawing layer and the voice over layer together with the processor to create an audiovisual session image in the memory.

8. A method in accordance with claim 7, wherein the graphical input and graphical content comprises one or more of the following:
inputs indicative of the user selecting, by means of the touchscreen display, a predefined shape from a plurality of predefined shapes;
inputs indicative of the user positioning, by means of the touchscreen display, a predefined shape on an active viewing area of the touchscreen display;
inputs indicative of the user resizing, by means of the touchscreen display, a predefined shape;
inputs indicative of the user drawing freehand on the active viewing area, by means of the touchscreen display; or
inputs indicative of the user erasing the active viewing area, by means of the touchscreen display, to remove any then current graphical input and graphical content.

9. A method in accordance with claim 7, further comprising the following steps:
transmitting a session image from the memory using the communication device to a remote device; and
activating a push notification to appear on a display of the remote device indicative that the session image has been sent.

10. A method in accordance with claim 9, further comprising the following steps:
receiving a modified session image from a remote device with the communication device and storing the modified session image in the memory; and
activating a push notification to appear on the touchscreen display using the processor indicative that the modified session image has been received from the remote device.

11. A method in accordance with claim 10, further comprising displaying the modified session image from the memory to either the first video display area or the second video display area using the processor in response to the respective first or second playback start/pause inputs and the respective first or second frame control inputs.

12. A system for slow motion display of audiovisual content, comprising:
a mobile device having
a processor,
a touchscreen display operatively coupled to the processor and having a rectangular screen viewable in either a portrait orientation or a landscape orientation,
a memory operatively coupled to the processor, a communication device operatively coupled to the processor, and
a display orientation sensor operatively coupled to the processor;
executable code stored in the memory of the mobile device for storing a plurality of videos comprising audiovisual content in a memory of a mobile device;
executable code stored in the memory of the mobile device for providing a first video window on a touchscreen display of the mobile device, the first video window being configured by a processor of the mobile device to include
a first playback start/pause control operatively coupled to the processor for receiving first playback start/pause inputs from the touchscreen display and providing signals indicative of the first playback start/pause inputs to the processor,
a first frame control operatively coupled to the processor for receiving first frame control inputs from the touchscreen display and providing signals indicative of the first frame control inputs to the processor, and
a first video display area within which a first video of the plurality of videos is displayed from the memory by the processor in response to the signals indicative of the first playback start/pause inputs and the first frame control inputs;
executable code stored in the memory of the mobile device for determining, by a display orientation sensor of the mobile device, whether the touchscreen display is in a portrait orientation, wherein the height of the screen is greater than the width of the screen, or a landscape orientation, wherein the width of the screen is greater than the height of the screen, and providing an orientation signal to the processor indicative of the determined orientation of the touchscreen display;
executable code stored in the memory of the mobile device for configuring the touchscreen display, if the orientation signal received by the processor is indicative that the touchscreen display is in a portrait orientation, such that the first video window occupies substantially the entire viewing area of the touchscreen display; and
executable code stored in the memory of the mobile device for configuring the touchscreen display, if the orientation signal received by the processor is indicative that the touchscreen display is in a landscape orientation, such that the first video window occupies a first portion of the viewing area of the touchscreen display and an analysis window occupies a second portion of the viewing area of the touchscreen display adjacent to the first portion, wherein the analysis window includes either
if a second video has not been selected from the plurality of videos, a menu window displaying a list of videos stored in the memory and allowing selection of one of the plurality of videos as the second video, or
if a second video has been selected from the plurality of videos, a second video window, the second video window being configured by the processor to include
a second playback start/pause control operatively coupled to the processor for receiving second playback start/pause inputs from the touchscreen display and providing the second start/pause inputs to the processor,
a second frame control operatively coupled to the processor for receiving second frame control inputs from the touchscreen display and providing the second frame control inputs to the processor, and
a second video display area within which the second video is displayed from the memory by the processor in response to the second playback start/pause inputs and the second frame control inputs.
